(19) United States
(12) Patent Application Publication
(10) Pub. No.: US 2017/0328192 A1
(43) Pub. Date: Nov. 16, 2017

(54) GEOSTEERING BY ADJUSTABLE COORDINATE SYSTEMS AND RELATED METHODS

(71) Applicants: Stefan Wessling, Hannover (DE); Thomas Kruspe, Wietzendorf (DE); Ingo Forstner, Ahnsbeck (DE)

(72) Inventors: Stefan Wessling, Hannover (DE); Thomas Kruspe, Wietzendorf (DE); Ingo Forstner, Ahnsbeck (DE)

(73) Assignee: Baker Hughes Incorporated, Houston, TX (US)

(21) Appl. No.: 15/152,740

(22) Filed: May 12, 2016

(51) Int. Cl. E21B 44/00; E21B 47/18; E21B 47/14; E21B 47/12; E21B 47/06; E21B 7/10; E21B 47/026; E21B 47/022; E21B 41/00; E21B 10/00; G01V 99/00

(52) U.S. Cl. CPC E21B 44/00; G01V 99/005; E21B 47/18; E21B 47/14; E21B 47/123; E21B 47/122; E21B 47/12; E21B 7/10; E21B 47/06; E21B 47/026; E21B 47/02208; E21B 41/0092; E21B 10/00; E21B 47/065

(57) ABSTRACT

Systems and methods for drilling a borehole into the earth are provided. The systems and methods include drilling a first portion of a borehole with a drilling system comprising a disintegrating device, the first portion extending from the surface to a subsurface reference point, wherein steering within the first portion is performed based on a first coordinate system with a first origin, creating a second coordinate system, wherein the second coordinate system has a second origin that is related to subsurface reference point, and drilling a second portion of the borehole with the drilling system, wherein steering within the second portion is performed based on the second coordinate system.

### BACKGROUND

Boreholes are drilled into the earth for many purposes such as hydrocarbon production, geothermal production, and carbon dioxide sequestration. Many of these boreholes need to have a precise location and geometry in order to increase efficiency for its desired purpose. The geometry and relative precision of a drilled borehole generally includes, for example, depth or drilled distance, inclination, build-up rate, and azimuth, all of which may include various amounts of uncertainty. Hence, development of drilling control systems to increase the accuracy and precision of drilling boreholes would be well received in the drilling industry.

### BRIEF SUMMARY

Systems and methods for drilling a borehole into the earth are provided. The systems and methods include drilling a first portion of a borehole with a drilling system comprising a disintegrating device, the first portion extending from the surface to a subsurface reference point, wherein steering within the first portion is performed based on a first coordinate system with a first origin, creating a second coordinate system, wherein the second coordinate system has a second origin that is related to subsurface reference point, and drilling a second portion of the borehole with the drilling system, wherein steering within the second portion is performed based on the second coordinate system.

### BRIEF DESCRIPTION OF THE DRAWINGS

The following descriptions should not be considered limiting in any way. With reference to the accompanying drawings, like elements are numbered alike:

FIG. 1 depicts aspects of a drilling system for drilling a borehole into the earth that may employ one or more embodiments provided herein;

FIG. 2 depicts a flow process for adjusting a coordinate system in accordance with a non-limiting embodiment of the present disclosure;

FIG. 3A illustrates a drilling system drilling a well path indicating an uncertainty in the well path;

FIG. 3B illustrates a drilling system drilling a well path in accordance with an embodiment of the present disclosure and indicating a reduction in uncertainty in the well path;

FIG. 4 illustrates a resistivity distribution map of a downhole formation;

FIG. 5 illustrates a digital subsurface model based on the resistivity distribution map of FIG. 4;

FIG. 6 illustrates a second subsurface model based on seismic data used for adjusting a coordinate system in accordance with an embodiment of the present disclosure;

FIG. 7 is a flow process for adjusting a coordinate system for drilling boreholes in accordance with an embodiment of the present disclosure;

FIG. 8 is an illustration of an adjustment of one subsurface model with respect to another subsurface model at a subsurface reference point in accordance with an embodiment of the present disclosure;

FIG. 9 illustrates a drilling system drilling a well path in accordance with another embodiment of the present disclosure and indicating first and second coordinate systems; and

FIG. 10 is a flow process for drilling a wellbore in accordance with an embodiment of the present disclosure.

### DETAILED DESCRIPTION

A description of one or more embodiments of the disclosed apparatuses and methods are presented herein by way of illustration and example and are not intended to be limitations. Reference will be made to the appended to the figures.

Disclosed are apparatus and method for drilling a borehole into the earth. The method, which is implemented by the apparatus described herein or other controller, computer, and/or processor, provides a control approach that can be used to control a borehole trajectory that may be characterized, for example, by depth, drilled distance, inclination, azimuth, build-up-rate, distance to a formation boundary, distance to an object such as another borehole, a geologic object, a downhole installation, or any other borehole trajectory related parameter. As used herein, the term “depth” may be considered to be inclusive of “drilled distance” (also known as “measured depth”) in order to account for deviated or horizontal boreholes.

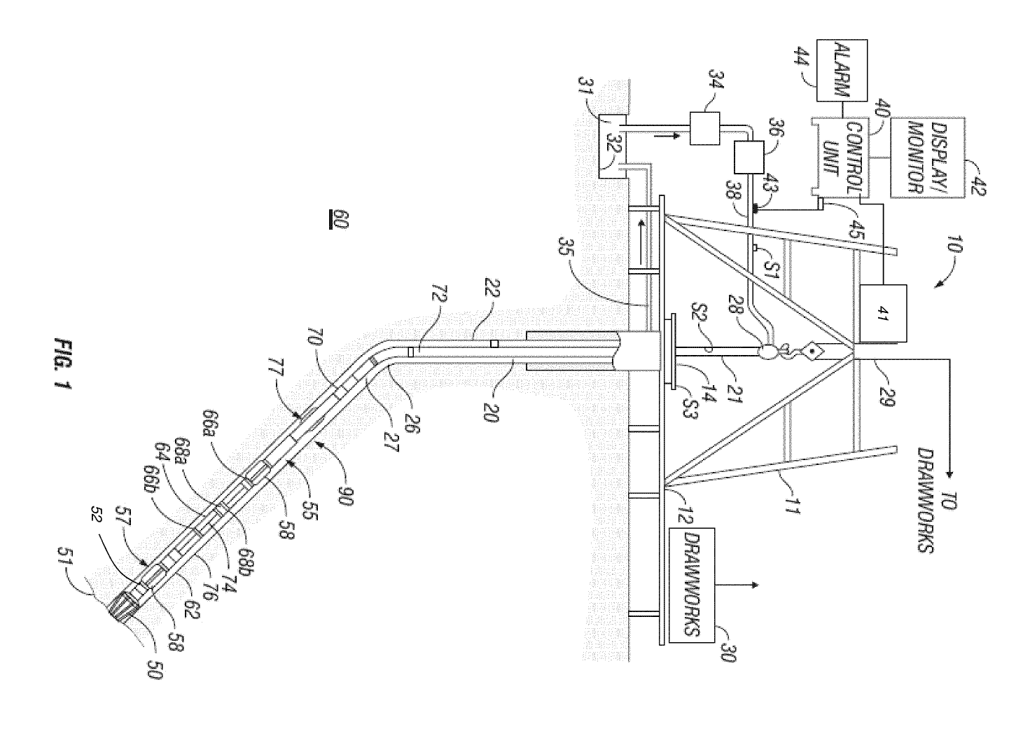

Apparatus for drilling operations related to this disclosure are now discussed. FIG. 1 shows a schematic diagram of a drilling system 10 that includes a drill string 20 having a drilling assembly 90, also referred to as a bottom hole assembly (BHA), conveyed in a borehole 26 penetrating an earth formation 60. The drilling system 10 includes a conventional derrick 11 erected on a floor 12 that supports a rotary table 14 that is rotated by a prime mover, such as an electric motor (not shown), at a desired rotational speed. The drill string 20 includes a drilling tubular 22, such as a drill pipe, extending downward from the rotary table 14 into the borehole 26. A disintegrating device 50 (e.g., a drill bit), attached to the end of the BHA 90, disintegrates the geological formations when it is rotated to drill the borehole 26. The drill string 20 is coupled to a drawworks 30 via a kelly joint 21, swivel 28 and line 29 through a pulley 23. During the drilling operations, the drawworks 30 is operated to control the weight on bit, which affects the rate of penetration. The operation of the drawworks 30 is well known in the art and is thus not described in detail herein. As used herein, the rotary table 14 and/or the kelly joint 21 form and/or include a rotary kelly bushing.

During drilling operations a suitable drilling fluid 31 (also referred to as the “mud”) from a source or mud pit 32 is circulated under pressure through the drill string 20 by a mud pump 34. The drilling fluid 31 passes into the drill string 20 via a desurger and fluid control valve 36, fluid line 38, and the kelly joint 21. The drilling fluid 31 is discharged at the borehole bottom 51 through an opening in the disintegrating device 50. The drilling fluid 31 circulates uphole through the annular space 27 between the drill string 20 and the borehole 26 and returns to the mud pit 32 via a return line 35. A sensor S1 in the line 38 provides information about the fluid flow rate. The flow rate can be controlled by a valve located in or near the pump 34 and/or the desurger and fluid control valve 36, or otherwise located within line 38. A surface torque sensor S2 and a sensor S3 associated with the drill string 20 respectively provide information about the torque and the rotational speed of the drill string. Additionally, one or more sensors (not shown) associated with line 29 are used to provide the hook load of the drill string 20 and about other desired parameters relating to the drilling of the wellbore 26. The system may further include one or more downhole sensors 70 located on the drill string 20 and/or the BHA 90. The downhole sensors 70 can include one or more sensors configured to sense, measure, and/or detect, for example, a position, orientation, inclination, and/or azimuth of the sensor(s) and/or BHA or other downhole component.

In some applications the disintegrating device 50 is rotated by only rotating the drill pipe 22. However, in other applications, a drilling motor 55 (mud motor) disposed in the drilling assembly 90 is used to rotate the disintegrating device 50 and/or to superimpose or supplement the rotation of the drill string 20. In either case, the rate of penetration (ROP) of the disintegrating device 50 into the borehole 26 for a given formation and a drilling assembly largely depends upon the weight on bit and the disintegrating device rotational speed. In one aspect of the embodiment of FIG. 1, the mud motor 55 is coupled to the disintegrating device 50 via a drive shaft (not shown) disposed in a bearing assembly 57. The mud motor 55 rotates the disintegrating device 50 when the drilling fluid 31 passes through the mud motor 55 under pressure. The bearing assembly 57 supports the radial and axial forces of the disintegrating device 50, the downthrust of the drilling motor and the reactive upward loading from the applied weight on bit. Stabilizers 58 coupled to the bearing assembly 57 and other suitable locations act as centralizers for the lowermost portion of the mud motor assembly and other such suitable locations.

A surface control unit 40 receives signals from the downhole sensors 70 and devices via a sensor 43 placed in the fluid line 38 as well as from sensors S1, S2, S3, hook load sensors and any other sensors used in the system and processes such signals according to programmed instructions provided to the surface control unit 40. The surface control unit 40 displays desired drilling parameters and other information on a display/monitor 42 for use by an operator at the rig site to control the drilling operations. The surface control unit 40 contains a computer, memory for storing data, computer programs, models and algorithms accessible to a processor in the computer, a recorder, such as tape unit for recording data and other peripherals. The surface control unit 40 also may include simulation models for use by the computer to processes data according to programmed instructions. The control unit responds to user commands entered through a suitable device, such as a keyboard. The control unit 40 is adapted to activate alarms 44 when certain unsafe or undesirable operating conditions occur.

The drilling assembly 90 also contains other sensors and devices or tools for providing a variety of measurements relating to the formation surrounding the borehole and for drilling the wellbore 26 along a desired path. Such devices may include a device for measuring the formation resistivity near and/or in front of the disintegrating device 50, a gamma ray device for measuring the formation gamma ray intensity and devices for determining the inclination, azimuth and position of the drill string. A formation resistivity tool 64, made according an embodiment described herein may be coupled at any suitable location, including above a lower kick-off subassembly 62, for estimating or determining the resistivity of the formation near or in front of the disintegrating device 50 or at other suitable locations. An inclinometer 74 and a gamma ray device 76 may be suitably placed for respectively determining the inclination of the BHA and the formation gamma ray intensity. Any suitable inclinometer and gamma ray device may be utilized. In addition, an azimuth device (not shown), such as a magnetometer or a gyroscopic device, may be utilized to determine the drill string azimuth. Such devices are known in the art and therefore are not described in detail herein. In the above-described exemplary configuration, the mud motor 55 transfers power to the disintegrating device 50 via a hollow shaft that also enables the drilling fluid to pass from the mud motor 55 to the disintegrating device 50. In an alternative embodiment of the drill string 20, the mud motor 55 may be coupled below the resistivity measuring device 64 or at any other suitable place.

Still referring to FIG. 1, other logging-while-drilling (LWD) devices (generally denoted herein by numeral 77), such as devices for measuring acoustic slowness, acoustic impedance, formation porosity, permeability, density, rock properties, fluid properties, etc. may be placed at suitable locations in the drilling assembly 90 for providing information useful for evaluating the subsurface formations along borehole 26. Such devices may include, but are not limited to, acoustic tools, nuclear tools, nuclear magnetic resonance tools and formation testing and sampling tools.

The above-noted devices transmit data to a downhole telemetry system 72, which in turn transmits the received data uphole to the surface control unit 40. The downhole telemetry system 72 also receives signals and data from the surface control unit 40 and transmits such received signals and data to the appropriate downhole devices. In one aspect, a mud pulse telemetry system may be used to communicate data between the downhole sensors 70 and devices and the surface equipment during drilling operations. A transducer 43 placed in the mud supply line 38 detects the mud pulses responsive to the data transmitted by the downhole telemetry 72. Transducer 43 generates electrical signals in response to the mud pressure variations and transmits such signals via a conductor 45 to the surface control unit 40. In other aspects, any other suitable telemetry system may be used for two-way data communication between the surface and the BHA 90, including but not limited to, an acoustic telemetry system, an electro-magnetic telemetry system, a wireless telemetry system that may utilize repeaters in the drill string or the wellbore and a wired pipe. The wired pipe may be made up by joining drill pipe sections, wherein each pipe section includes a data communication link that runs along the pipe. The data connection between the pipe sections may be made by any suitable method, including but not limited to, hard electrical or optical connections, induction, capacitive or resonant coupling methods. In case a coiled-tubing is used as the drill pipe 22, the data communication link may be run along a side of the coiled-tubing.

The drilling system described thus far relates to those drilling systems that utilize a drill pipe to conveying the drilling assembly 90 into the borehole 26, wherein the weight on bit is controlled from the surface, typically by controlling the operation of the drawworks. However, a large number of the current drilling systems, especially for drilling highly deviated and horizontal wellbores, utilize coiled-tubing for conveying the drilling assembly downhole. In such application a thruster is sometimes deployed in the drill string to provide the desired force on the disintegrating device. Also, when coiled-tubing is utilized, the tubing is not rotated by a rotary table but instead it is injected into the wellbore by a suitable injector while the downhole motor, such as mud motor 55, rotates the disintegrating device 50. For offshore drilling, an offshore rig or a vessel is used to support the drilling equipment, including the drill string.

Still referring to FIG. 1, a resistivity tool 64 may be provided that includes, for example, a plurality of antennas including, for example, transmitters 66a or 66b or and receivers 68a or 68b. Resistivity can be one formation property that is of interest in making drilling decisions. Those of skill in the art will appreciate that other formation property tools can be employed with or in place of the resistivity tool 64.

For example, an acoustic tool can be provided which transmits acoustic waves into the formation. These acoustic waves can be reflected at geological rock and/or fluid boundaries with high acoustic impedance contrasts so that the travel time of reflected waves can be recorded by the acoustic tool. Processing algorithms, such as migration, can be used to derive a position of acoustic reflectors in the vicinity of the borehole using an appropriate velocity model for the formation surrounding the borehole. Such approach is sometimes referred to as deep-shear-wave-imaging or -deep-compressional-wave-imaging.

Additionally, other downhole tools can be used and/or employed for steering and/or geosteering when drilling a borehole. For example, various downhole tools can include, but are not limited to, gamma, nuclear, magnetic resonance, nuclear magnetic resonance, resistivity tools, etc. Further, different measurement and/or testing types and configurations can be used without departing from the scope of the present disclosure. For example, measurements can include bulk measurements, oriented measurements, un-oriented measurements, etc., as known in the art.

As noted above, the drilling fluid 31 is pumped by a drilling fluid pump 34 and a flow rate of the drilling fluid is controlled by a desurger and drilling fluid control valve 36. The drilling fluid pump 34 and flow control valve 36 are controlled by a drilling parameter controller 41 and/or the control unit 40 to maintain a suitable pressure and flow rate to prevent the borehole 26 from collapsing. The term “drilling fluid” is intended to be inclusive of all types of drilling fluids known in the art including, but not limited to, oil-based mud, water-based mud, foam, gas, and air. The drilling parameter controller 41 is configured to control, such as by feedback control for example, parameters of drilling equipment used to drill the borehole 26.

One or more surface sensors (e.g., S1, S2, S3, 43) or downhole sensors 70 (within drilling assembly 90 and/or along drill string 20) may be used to provide feedback signals to the drilling parameter controller 41 for feedback control of drilling equipment. Non-limiting embodiments of drilling parameters include weight-on-bit, hook load, torque, drill bit rotational speed (e.g., rpm), rate-of-penetration, pressure, mud flow rate, and formation evaluation measurements as described below. Control references, also known as set points, which may include set points related to a trajectory plan, can be transmitted to the drilling parameter controller 41 by the control unit 40 (e.g., a computer processing system).

In an alternative configuration, the drilling parameter controller 41 may utilize, include, comprise, or be part of the control unit 40. The drilling parameter controller 41 can be, in some embodiments, installed downhole, for instance in BHA 90. The drilling parameter controller 41 can include one or more controlling elements (not shown) configured to deal with various components, features, and/or variables of the controlling aspects and which can be installed downhole or on surface or both. One or more stabilizers (not shown) may be disposed at various locations on the drill tubular, for instance at one or more distances L₁ (i=1, 2, 3 . . . ) from the disintegrating device 50.

As noted, the BHA 90 and/or drill string 20 includes one or more downhole sensors 70 configured for sensing one or more downhole properties or parameters related to the earth formation 60, the borehole 20, the drilling fluid 31, the drill string 20, the BHA 90, etc. Parameters associated with the BHA 90 that may be sensors and/or monitored can include, position of the BHA 90, orientation of the BHA 90, inclination of the BHA 90, tool face of the BHA 90, and/or azimuth of the BHA 90. Sensor data can be transmitted to the surface by the telemetry system 72 for processing by the control unit 40.

Data acquisition by the downhole sensor(s) 70 while drilling the borehole 26 may be referred to as measurement-while-drilling (MWD) or logging-while-drilling (LWD). Sensed data can be correlated to a depth or a time at which the data was obtained to provide a depth-based or a time-based log. One example for a downhole sensor 70 is a formation evaluation sensor which can be a sensor configured to sense gamma-ray radiation. The gamma-ray radiation may be natural or may result from neutron bombardment of the formation, such as by a pulsed neutron generator, a radioactive source, or any other suitable neutron source known in the art. In other embodiments or in combination therewith, the downhole sensor(s) 70 can include sensors configured to sense resistivity, neutron radiation, acoustic energy, electromagnetic energy, electric energy, magnetic energy, nuclear magnetic resonance properties, chemical properties, formation porosity, formation density, formation permeability, fluid density, fluid viscosity, temperature, pressure, magnetic fields, force, acceleration, and/or gravity. The downhole sensor(s) 70 can comprise active or passive sensing elements. The downhole sensors 70 can operate as a part of a sensor system (e.g., as part of BHA 90) comprising transmitting and receiving elements. The downhole sensor(s) 70 may provide sensed measurements or data that is measured system output to the drilling parameter controller 41 for feedback control purposes.

The BHA 90, as shown, includes a steering system 52. The steering system 52 is configured to steer the disintegrating device 50 in order to control orientation of the BHA 90 in order to allow drilling the borehole 26 according to a selected path or geometry (for instance, by following a planned geometric path or by keeping a distance to an object). The steering system 52 can control, for example, inclination, azimuth, and/or tool face of the BHA 90. Further, the steering system 52 controls the BHA 90 and/or the disintegrating device 50 to follow a planned geometric path or by controlling the BHA and drill string 20 to keep a desired distance to or from an object in the earth formation 60.

For steering the BHA 90 or disintegrating device 50, the steering system 52 includes one or more actuators that are configured to convert a controller output from the drilling parameter controller 41 into a motion that can alter the path being drilled by the disintegrating device 50. For example in a rotary steering system (RSS), an actuator can be a piston that moves a pad for providing a force exerted against a borehole wall thus steering the BHA 90 and the disintegrating device 50. In an alternative embodiment, steering the BHA 90 can be controlled using bent downhole motors (not shown) where behavior can be changed through rotating or non-rotating (i.e., sliding) the drill string 20. Bent drilling motors can be used with a fixed bend that cannot be varied during normal operation or with a variable bend that, for example, can be varied based on a controller output of the drilling parameter controller 41. In embodiments with a variable bend, actuators can be included in the bent downhole motor that are configured to create or vary the bend, thereby affecting the steering behavior of the steering system.

Accordingly, the term “steering system” is to be construed as including those components both downhole and/or at the surface (e.g., rotary table 14 and/or drilling fluid pump 34) that operate in order to control a trajectory or orientation of the drill string 20 and/or the disintegrating device 50 for drilling the borehole 26. It can be appreciated that the output of the control unit 40 and/or the drilling parameter controller 41 can be generated within the steering system 52 and does not necessarily need to be received from a source external to the steering system 52. Accordingly, the term “controller output” is to be construed as including controller outputs that are received from a source external to the steering system 52 and/or generated internal to the steering system 52.

In order to provide controller outputs (for example, a control signal or a system input) to the steering system 51 for controlling the trajectory or orientation of the disintegrating device 50, the drilling parameter controller 41 is configured to implement a trajectory control algorithm, discussed below. Operation of the trajectory control algorithm employs a processor such as in the control unit 40, the drilling parameter controller 41, and/or other processing system.

In various embodiments, the drilling parameter controller 41 can be disposed downhole, at the surface, and/or functions can be split between a surface processor and a downhole processor. Steering commands or other controller outputs can be transmitted from the drilling parameter controller 41 to the steering system 51 by telemetry. In addition, other information of interest (e.g., rate-of-penetration or position, depth, drilled distance, orientation, and/other sensor measurements) can be transmitted using telemetry. Telemetry in one or more embodiments may include mud pulse telemetry, acoustic telemetry, electromagnetic telemetry, and/or wired pipe telemetry. Downhole electronics 11 may process data downhole and/or act as an interface with the telemetry. In other embodiments, the downhole electronics within the BHA 90 can be configured to implement the trajectory control algorithm or portions thereof. In such embodiments, the control unit 40 can transmit a desired trajectory (i.e., trajectory plan) or parts of the trajectory if that is all that is needed, to the BHA 90, steering system 51, and/or drilling parameter controller 41. In some embodiments, if the trajectory is described as a parameterized curve, only the parameters can be transmitted. In non-limiting embodiments, the trajectory can be in absolute coordinates (such as north-east-down) or the trajectory can be a time or depth sequence for the orientation (such as inclination, azimuth, tool face), or a distance to an object.

In traditional geo-steering operations, a Cartesian coordinate system is employed with a Rotary Kelly Bushing (RKB) located on the surface as reference or origin point. Steering is then conducted from the surface via downlink by sending steering change commands such as change angle or change rate relative to the coordinate system referenced at surface (e.g., the Cartesian system based on the surface reference point). The position of the drill bit and the well path are then defined by the azimuth, inclination, and measured depth (and/or other set(s) of parameters) acquired by downhole sensors in the BHA and surface sensors positioned at the rig. A systematic error can be introduced by this type of dead-reckoning navigation which becomes larger with increasing measured depth.

Accordingly, embodiments provided herein introduce an adjustable and/or adaptable coordinate system with a reference point(s) that are located subsurface (e.g., within the formation and/or downhole) instead of at the surface (e.g., based on an RKB) for automated geo-steering within the adjusted coordinate system. In accordance with some embodiments, the reference or origin point of the adjustable coordinate system is based on geological features, such as bed boundaries or oil-water-contact (OWC), or other markers for which either an absolute or a relative location can be defined with less uncertainty compared to a surface coordinate system. The adjustable coordinate system can be adjusted in real-time with new formation evaluation data processed.

Advantageously, geo-steering may become easier and more accurate, as compared to systems based on surface coordinates, because systematic position errors introduced by dead-reckoning can be “reset” to zero by adjusting the reference or origin point to a known position in the subsurface. Commands from surface components (e.g., control systems, computers, etc.) can contain instructions based on the downhole, adjustable coordinate system. For example, an instruction can contain steering instructions made relative to a downhole feature (e.g., “stay x meters above the OWC”). A downhole computing unit (e.g., part of the BHA) combines the command from the surface with real-time, high-resolution formation evaluation data. The downhole computing unit then identifies the relative location of the BHA to the geological feature and then actuates the necessary directional steering.

Further, advantageously, an adjustable geologically-based (or otherwise re-referenced) coordinate system as provided herein can decrease relative positional uncertainty of different finite element-readings to each other. For example, each reading does not have to be related to each other via a geospatial coordinate system that adds (potentially significant) uncertainty. Further, such geospatial coordinate systems errors and/or uncertainty can grow toward a toe of a reservoir section due to incremental uncertainties with depth of a “dead-reckoning” method.

Accordingly, systems and methods for altering coordinate systems of subsurface models for visual inspection and subsequent adjustment of a well path are disclosed. Adjustments, as employed herein, take into consideration various sources of uncertainty of different sub-models of a subsurface under consideration. The coordinate system can be used by surface-based or downhole based computing units (e.g., surface control units, BHA components, etc.). The systems and methods provided herein can reduce uncertainty associated with steering boreholes, as compared to surface-based coordinate systems that experience increasing uncertainty with increasing measured depth.

In geo-steering or well positioning operations, dead-reckoning or deduced-reckoning is a process of calculating a current position by using a previously determined position, and advancing that position based upon known or estimated drilling speeds over elapsed time and course. Although dead-reckoning can give the best available information on position, it is subject to significant errors due to many factors as both speed and direction must be accurately known at all instances of a drilling operation for position to be determined accurately. For example, if measured depth is measured by the number of stands (pipes), any discrepancy between the actual and assumed length of the stands, due perhaps to sensor inaccuracies, can be a source of error. As each estimate of position is relative to the previous one, errors can be cumulative.

Accordingly, to minimize the cumulative errors and/or uncertainty, in accordance with embodiments provided herein, a coordinate system for steering a wellbore through a subsurface formation is adjusted by transferring a reference or origin of a coordinate system to a marker point located subsurface. Subsurface-based (e.g., reservoir, OWC, etc.) coordinate systems allow for automated steering, following for example an x-y plane of a certain geological feature. Such adjusted coordinate system allows commands from the surface to be minimized. For example a surface command can include a specific command within the adjusted coordinate system, such as “stay 1 m above OWC.” Such surface commands can be limited to relevant commands related to production and, further, may be made less frequently than traditional surface controlled system. Moreover, embodiments provided herein may minimize blind time periods of downlinks at which no uplinking is decoded.

Embodiments provided herein employ alteration and/or adjusting of position(s) of supplementary subsurface models according to the sources of uncertainty of their positions. The approach adds value in a way to provide an intuitive means of visually inspecting different subsurface models for a combined interpretation. Different measurements such as seismic and resistivity and coordinate systems based on the various models are related directly to each other positionally for geosteering without intermediate reference of a geospatial coordinate system. Accordingly, relative uncertainty can be reduced.

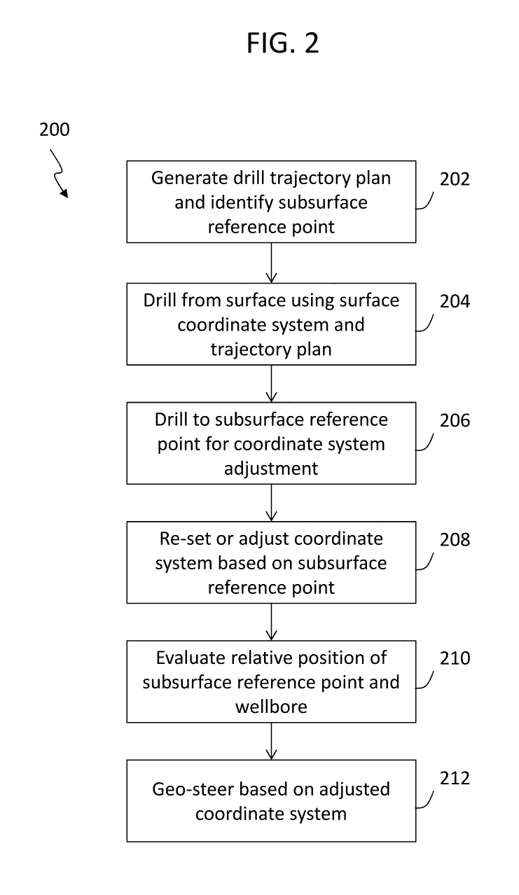

Turning now to FIG. 2, a flow process for adjusting a coordinate system in accordance with a non-limiting embodiment of the present disclosure is shown. The flow process 200 can be performed by a drilling system (e.g., drilling system 10) and can include operations and/or computing performed at the surface (e.g., control unit 40, drilling parameter controller 41, etc.) and/or downhole (e.g., BHA 90).

At block 202, a first subsurface model or other projection is used to generate a drill trajectory plan and to identify one or more subsurface reference points (e.g., anchor points). As used herein, the subsurface reference points are points in a current or first coordinate system that are a location at which an adjusted or second coordinate system will be implemented. That is, the subsurface reference points are different markers, reference points, anchor points, origins, etc. that are used in an adjusted or second coordinate system that is different than a geospatial RKB or other reference point at surface (i.e., different from the first coordinate system). The subsurface reference points may be various known and/or predicted geological and/or downhole features. For example, subsurface reference points can include, but are not limited to, top of a reservoir, oil-water-contact surface, known composition transitions, etc. Accordingly, the subsurface reference points are based on one or more downhole formation characteristics (e.g., modeled, measured, detected, known, implemented, etc.).

As noted, multiple subsurface reference points can be used such that the coordinate system can be updated multiple times in a single borehole drilling operation. For example, a first subsurface reference point can be a formation boundary (e.g., between two types of formations downhole), and a second subsurface reference point can be an oil-water-contact that is located further along the trajectory plan (i.e., the first subsurface reference point is the basis for a coordinate system until the second subsurface reference point is reached, and then the coordinate system is updated or adjusted a second time).

Those of skill in the art may recognize that subsurface reference points, as used herein, do not necessarily have to be located at or in close proximity and/or within the vicinity of the borehole and/or well trajectory. For example, deep-reading measurements such as resistivity measurements used for reservoir navigation purposes can be used to detect a formation boundary a large distance away from the well trajectory. The detection of a subsurface reference point may thus be defined as the detection of a geological feature a distance X away from the well trajectory, in which the distance X can be any distance and can be bounded by various factors including the scope of a detection tool or tools. Likewise, any other type of measurement may be used to detect and/or identify a subsurface reference point, including but not limited to acoustic slowness measurements, acoustic impedance measurements, nuclear magnetic resonance measurements, electromagnetic measurements, hydraulic measurements, nuclear measurements (e.g., gamma, neutron, density, etc.), and/or other measurements as known in the art.

Accordingly, at block 202, a drilling operational plan (e.g., trajectory plan) can be prepared with a known subsurface reference point predetermined. That is, the trajectory plan can be based on a surface or first coordinate system (e.g., geospatial RKB system) and used to drill to the predetermined subsurface reference point (e.g., downhole boundary). Note that, for clarity, a subsurface reference point is defined different from a subsurface target. A subsurface reference point, as used herein, refers to a position or location within the subsurface which is used to adjust a coordinate system, whereas a subsurface target is referred to as a location or position which is aimed to be reached by a drilling operation. Commonly, equivalent terms for a subsurface target are also known as total depth, total target, or similar, and may be specified by a position or location in the subsurface using common geographic or other coordinate systems.

At block 204, a drilling operation is performed from the surface using the first (e.g., surface-based) coordinate system to drill a first portion of a borehole. For example, as noted, an RKB reference or coordinate system can be used during the beginning and early stages of drilling. However, as noted above, as the depth and length of the borehole increases, so too do the uncertainties and/or errors. Accordingly, the beginning portion of the drilling operation is performed based on the surface coordinate system, and the drilling is performed until a first subsurface reference point is reached.

At block 206, the drilling and associated steering is performed until the wellbore reaches the first subsurface reference point (e.g., completes the first portion of the borehole). At this time, the drilling operation can be halted such that the trajectory plan can be updated based on a new, second (e.g., adjusted) coordinate system, as described herein, at block 208. For example, a second subsurface model can be used to adjust and/or be the basis of the second coordinate system. At block 210, an evaluation of the position of the BHA and/or drilling tools can be made based on relative positions of the subsurface reference point and the wellbore. Then, at block 212, geo-steering and/or drilling may be resumed in line with the trajectory plan along a second portion of the borehole, with reduced uncertainty and/or error, based on the second coordinate system. That is, the second portion of the borehole extends from the end of the first portion of the borehole, or stated another way, the second portion of the borehole extends from the subsurface reference point into the earth.

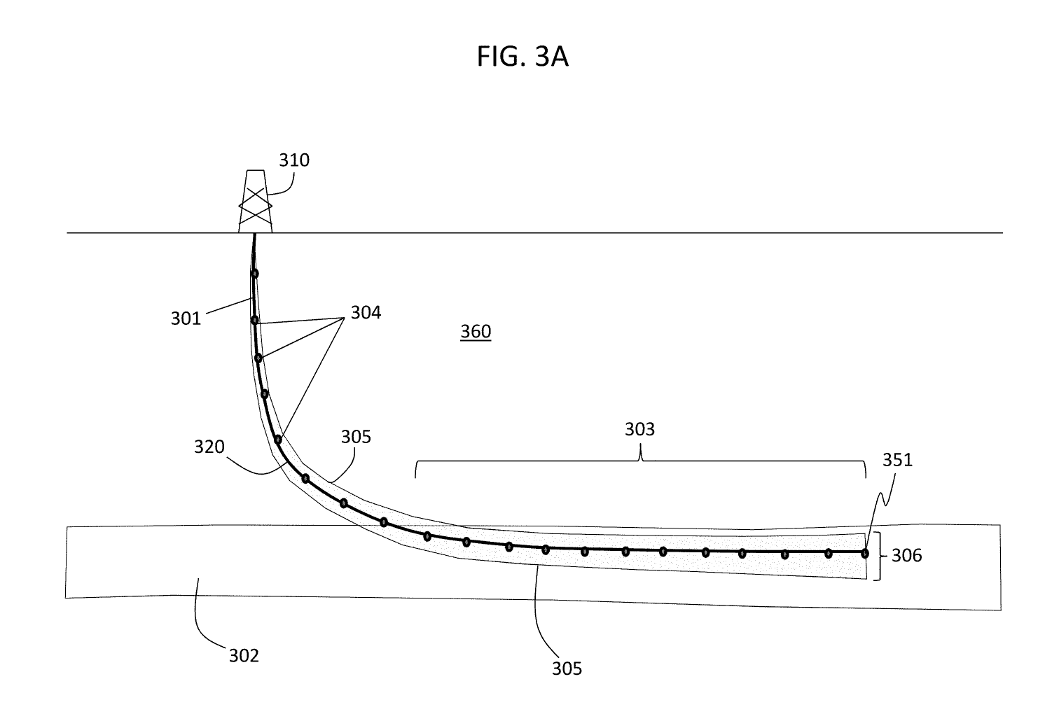

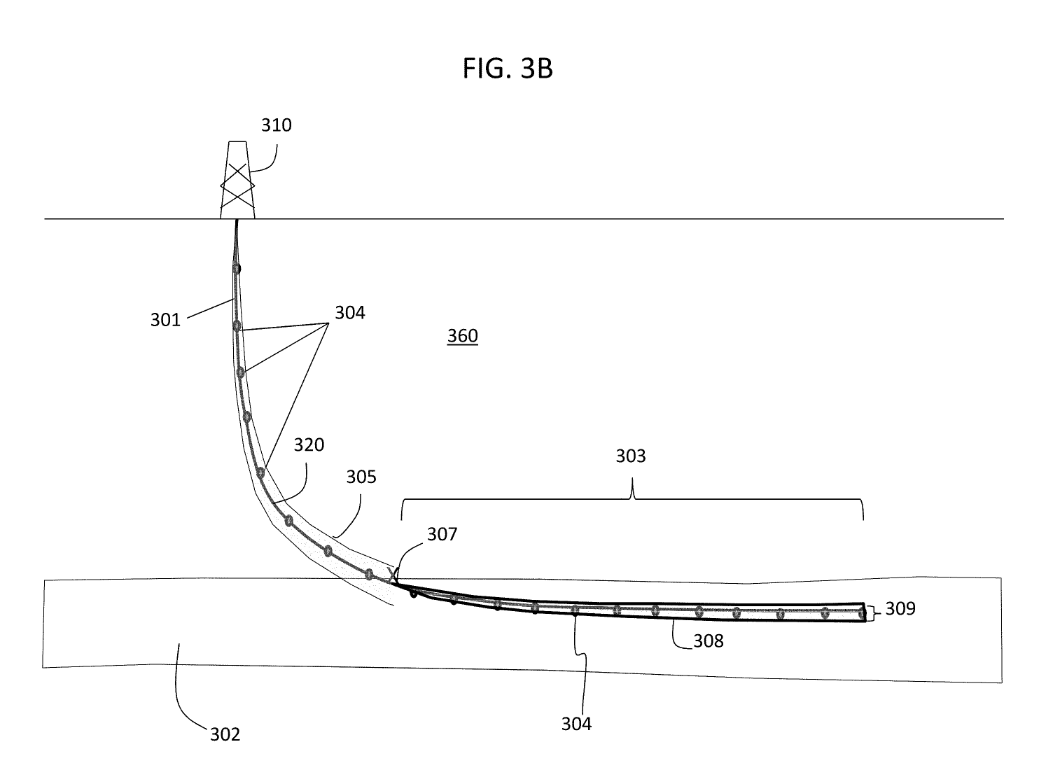

FIGS. 3A-3B illustrate a reduction in uncertainty that can be achieved by employing embodiments described herein. FIGS. 3A-3B each illustrate a drilling system 310 drilling a well path 301 using a drill string 320 which includes a BHA and/or drilling components and tools (as described above). Drilling is configured to begin at a rig or other surface equipment (part of drilling system 310) and pass through an earth formation 360 to a reservoir 302. As illustrated in FIGS. 3A-3B, the well path 301 includes a section that is drilled through the reservoir 302. The drilling operation that takes place within the reservoir 302 is indicated as reservoir navigation 303.

As shown in FIG. 3A, the well path 301 includes a number of survey points 304 at which, for example, an azimuthal and/or inclination measurement is conducted and transmitted to the surface system. The survey points 304 can be defined in the trajectory plan of the drilling system 310. When each survey point 304 is reached during a drilling operation, the drilling system (or operators thereof) can determine the current position and heading of the drilling operation. Accordingly, at each survey point 304 the steering of the drilling operation can be reviewed and updated to ensure that the drilling operation is in line with the well path 301. However, as noted, each time the review and update is made an amount of uncertainty is introduced, and is indicated as well uncertainty region 305. As shown, the size of the well uncertainty region 305 increases with each subsequent survey point 304, even within the reservoir 302. When the drilling has reached a borehole bottom 351, the well uncertainty region 305 may be at an uncertainty maximum 306 that can lead to decreased production efficiency.

Turning now to FIG. 3B, the well plan 301 is configured with a subsurface reference point 307, which is preset as the boundary between the earth formation 360 and the reservoir 302. As shown, as the well path 301 extends downward from the surface components to the subsurface reference point 307, a certain amount of uncertainty will be present in the position or location of the wellbore due to the uncertainty imposed from the survey points 304 that are above the subsurface reference point 307. The well uncertainty region 305 is indicated in FIG. 3B. However, once the reservoir 302 (and thus subsurface reference point 307) is achieved, within the uncertainty of well uncertainty region 305, the drilling operation is reset or changed to a second coordinate system that is based on the subsurface reference point 307.

For example, as shown, the drilling within the reservoir navigation 303 has the uncertainty reset, and further drilling is subject to only a small amount of uncertainty, as indicated by adjusted uncertainty region 308. The drilling operation within the reservoir 302 continues to include survey points 304. However, the survey points 304 within the reservoir 302 are calculated with respect to a coordinate system that is based on the subsurface reference point 307. This can lead to significant reductions in the amount of uncertainty that occurs within the adjusted uncertainty region 308. Accordingly, as shown, a final uncertainty 309 is significantly less than the uncertainty maximum 306 (FIG. 3A) that occurs when a surface-based coordinate system is used for the entire well path 301.

Although FIG. 3B shows a single subsurface reference point 307, those of skill in the art will appreciate that the subsurface reference point can be set or reset multiple times. For example, the subsurface reference point can be reset each time a reservoir or key geological features or other marker is passed by the drilling operation, e.g., multiple reservoirs, key geological features, and/or markers. In some embodiments, as shown in FIG. 3B, there is a single reset of the navigation system for “dead reckoning” after re-selecting the origin of the reference system (e.g., at subsurface reference point 307). In other embodiments, as provided herein, the reference system can be continually updated with local reference to various reservoir and/or geological features.

In some embodiments, a process of relating or associating different formation evaluation data sets to each other is provided. For example, in some embodiments, the subsurface reference point (e.g., anchor point, marker point, origin, etc.) is defined by evaluating relative positions between the wellbore and a subsurface model. The subsurface model can be a reservoir navigation model, a subsurface model derived from surface seismic data, etc. Different models may exhibit different uncertainties and thus an evaluation of relative positions against each other can be evaluated. One means of this evaluation is a visual inspection of the different models and then performing an adjustment of the models based on the visual inspection. The adjustment can be conducted based on the major source of uncertainty of each model.

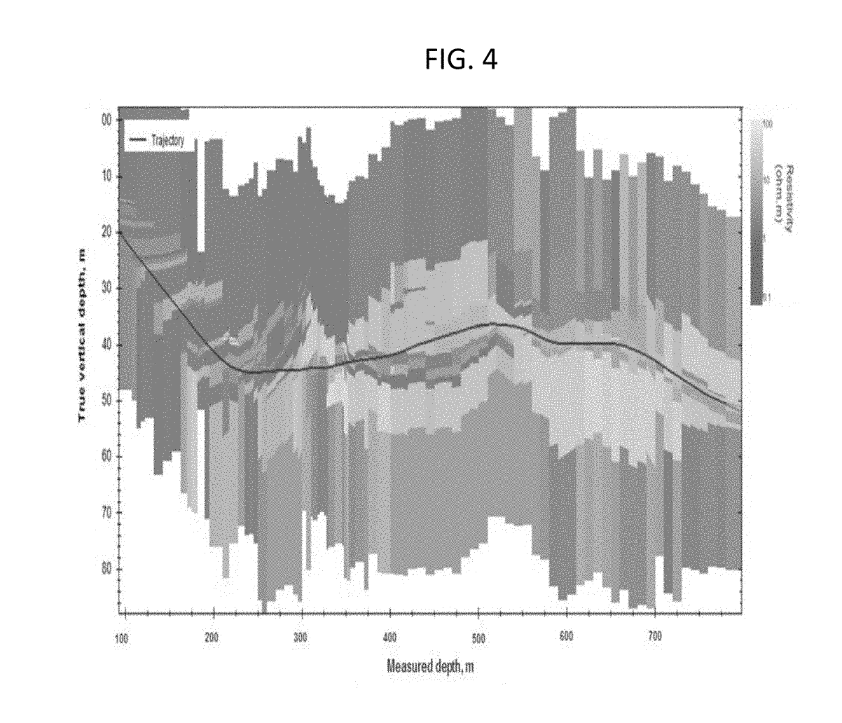

In one non-limiting example, a common deliverable from a reservoir navigation service is a resistivity distribution map such as shown in FIG. 4. The resistivity distribution map can provide insight regarding the architecture of the reservoir and/or downhole environment. In particular, the reservoir boundaries can be mapped very well in this example. The resistivity distribution map of FIG. 4 is an outcome of a forward and/or inversion calculation of deep-reading electromagnetic tools.

The derived resistivity distribution map of FIG. 4 can be referenced to a well trajectory along which electromagnetic tools have been positioned for data acquisition. The accuracy and/or uncertainty of the position/location of the resistivity distribution map can thus be determined by the uncertainty of the well trajectory/position of the wellbore within the subsurface.

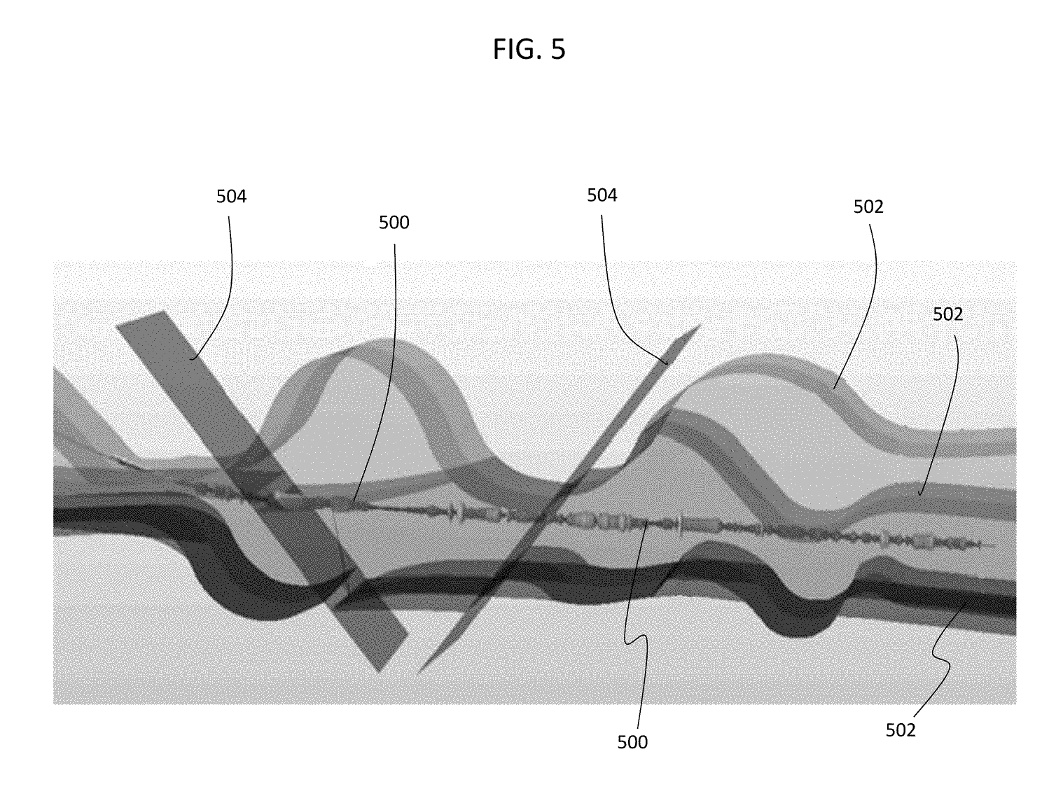

The resistivity distribution map (e.g., FIG. 4) can be used to create a digital subsurface model which represents geological structures, as shown in FIG. 5. For example, as shown in FIG. 5, a 2.5-dimensional representation may be constructed. The model in FIG. 5 is a two-dimensional representation of geological structures around a wellbore 500, with the structures having been extended in a lateral direction. As shown in FIG. 5, bed boundaries 502 and faults 504 are shown, although other features, including fractures, etc. can be illustrated and/or modeled. In non-limiting examples, the model can be represented in a curtain section along the well trajectory or in three dimensions.

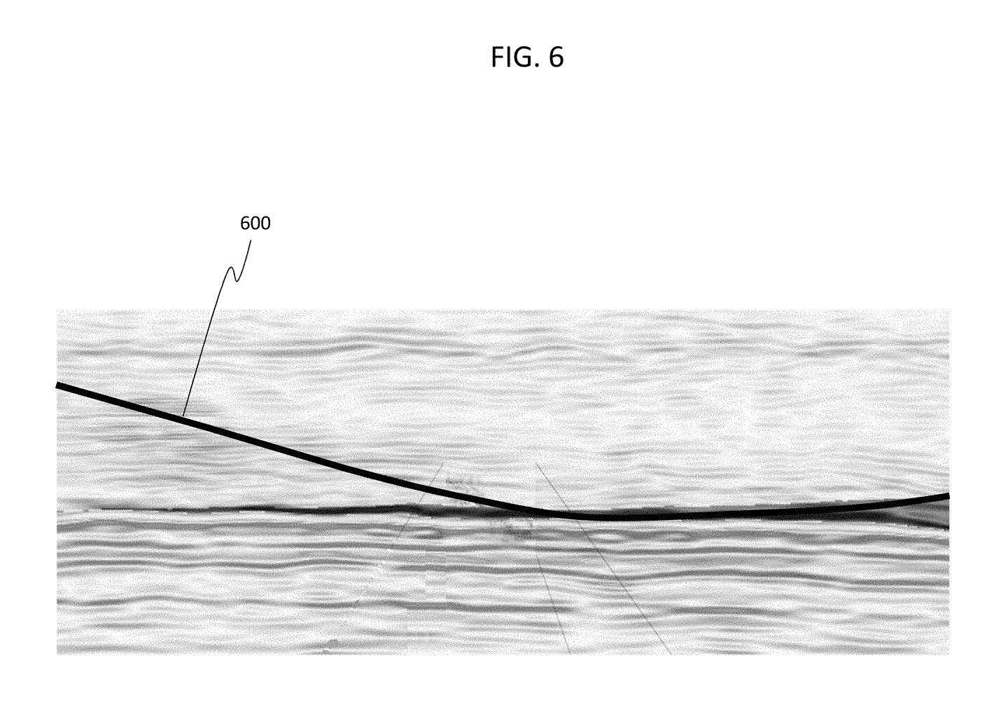

One essential challenge encountered with subsurface models from reservoir navigation services is related to the position in subsurface models derived from other acquisition methods. For example, uncertainties associated with different acquisition methods can impose addition uncertainties. One example for alternative subsurface models are the ones derived from surface seismic data, such as illustrated in FIG. 6. FIG. 6 illustrates a seismic cube with reflectors highlighted, as indicated by the variations in color density. Reflectors are bed boundaries or other formation or fluid boundaries exhibiting a sufficiently high acoustic impedance contrast to let seismic and/or acoustic waves to be reflected at those structures and/or features. A wellbore trajectory 600 is shown approaching a geological formation.

The reflectors within the seismic data can be selected to create a digital subsurface model. One part of creating the subsurface model is a time-to-depth conversion. To obtain a digital subsurface model, seismic waves are excited at the surface and travel through the subsurface until they are reflected by a boundary or other subsurface formation and/or feature. The arrival time of the reflected seismic waves are recorded at the surface and are referenced to time, and thus a conversion needs to be carried out to convert the time-based models of the seismic data into a depth-based space. The distribution of wave propagation velocities is used for this conversion, which provides a source of uncertainty for digital subsurface models derived from seismic data. In many cases, the largest uncertainty associated with surface seismic data is true vertical depth; hence the digital subsurface model may be off vertically.

One fundamental activity conducted by Geoscientists is the refinement of subsurface models based on an integrated interpretation of data from different acquisition sources. For example, the subsurface model derived from surface seismic data can be adjusted and/or refined by a reservoir navigation model derived from deep-reading electromagnetic well-logging tools (e.g., BHA tools, drilling string sensor systems, etc.). Any adjustment should take into account the uncertainties of the different acquisition methods, so that, depending on the source of uncertainty, different adjustment approaches are employed. Those of skill in the art will appreciate that adjustment of a subsurface model has an equivalent meaning of creating a second subsurface model which can be different from the original subsurface model. For example, rotation, manipulation, alteration, time- or depth-shift, or other change in any step to derive the adjusted subsurface model is considered a creation of a second subsurface model.

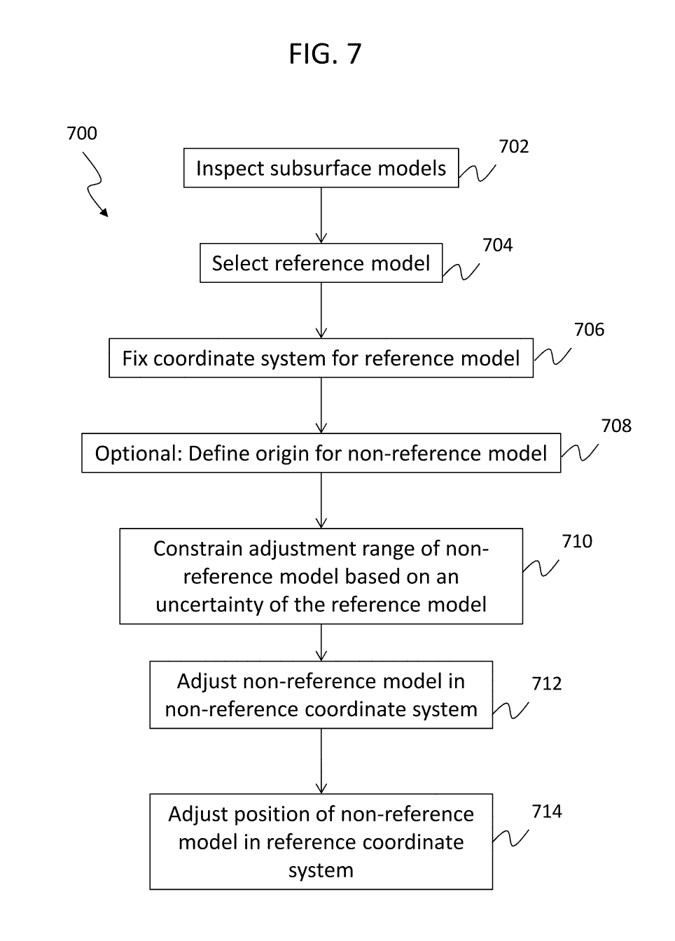

In one non-limiting embodiment, as noted above, a visual inspection of subsurface models can be useful. For example, a transparent reservoir navigation model (e.g., a first subsurface model) can be displayed on top of a seismic image (e.g., a second subsurface model) to evaluate if geological structures become visible within both data. Either the seismic image and/or the reservoir navigation model can be positioned differently for visual inspection. The positioning of the models should be conducted according to the source of uncertainty. A workflow to describe a procedure to visually inspect different subsurface models in different coordinate systems is provided in FIG. 7.

Flow process 700, as shown in FIG. 7, can be used with various types of formation and/or downhole models, and is not limited to any specific or particular model and/or models. At block 702, an operator or other person can make a visual inspection of subsurface models that have been generated by one or more computers, control units, etc. The subsurface models can be based on multiple different modeling methods and/or based on multiple different types of data and/or information used for modeling subsurface features, geology, formation structures, boundary lines, etc.

Based on the inspection of the various subsurface models at block 702, a first or reference model can be selected, as shown at block 704 (e.g., seismic data and modeling as shown in FIG. 6). The reference model that is selected can be based on the uncertainties associated with the particular model (e.g., selected to minimize uncertainties) or may be selected based on other criteria. For example, a subsurface model can be selected based on external criteria, e.g., based on prior modeling and/or wellbores that have been formed in the region.

At block 706, the selected subsurface model can be used to define a reference model and a coordinate system can be set based on the reference model. The reference model and associated coordinate system is based on the surface. However, once drilling is performed, as discussed above, the uncertainties will increase with depth.

Accordingly, at optional block 708, an origin (e.g., subsurface reference point) can be defined for a second or non-reference model (e.g., resistivity model as shown in FIG. 5). The original of the non-reference model can be used as a target or goal for a drilling operation to reach based on the reference model. The non-reference model is difference from the reference model. Then, at block 710, the non-reference model can be constrained based on uncertainties associated with the non-reference model.

At block 712, the non-reference model is adjusted within a coordinate system of the non-reference model. That is, as information is obtained, the non-reference model can be adjusted within its own coordinate system. Then, at block 714, the position of the non-reference model (relative to the reference model) can be adjusted within the reference model coordinate system.

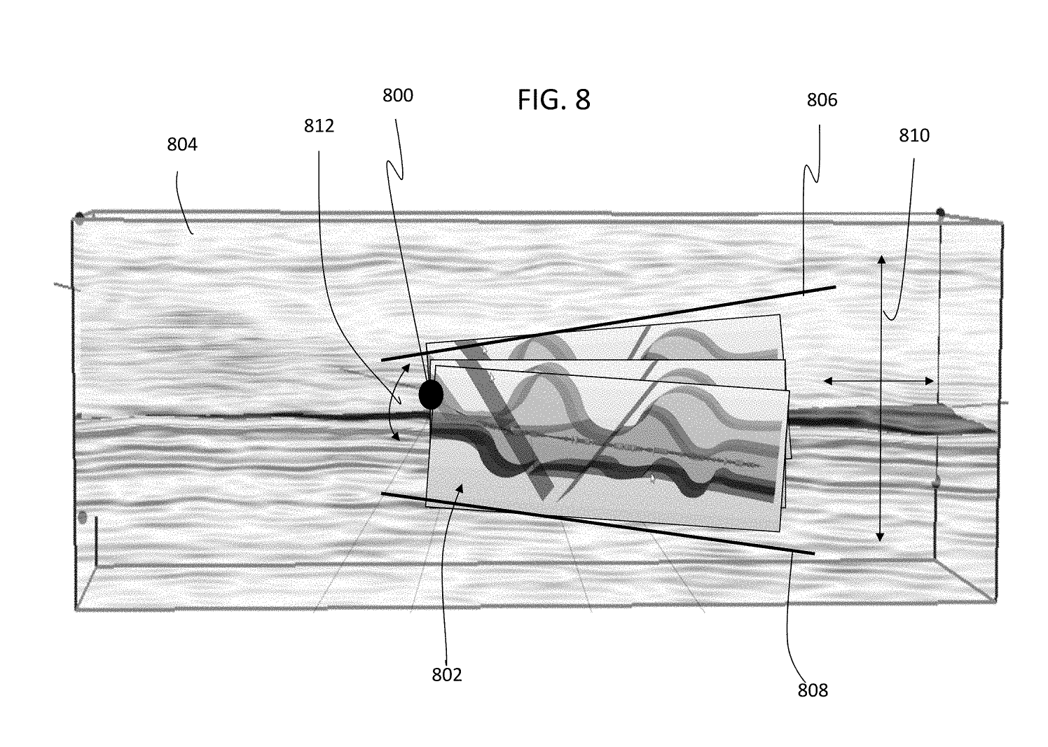

For example, as noted above, a seismic model can be obtained using seismic data. Further, resistivity data and/or modeling can be used to generate a resistivity model. The two models may not align correctly, and thus flow process 700 is used to enable correction of one model to the other, and thus accurate downhole modeling can be obtained. The adjustment of the non-reference model, for example, can be adjusted vertically to ensure that the two models align. Further, because a subsurface reference point is used, the non-reference model can be adjusted and/or rotated (e.g., tilted) with respect to the subsurface reference point. For example, the non-reference model (e.g., FIG. 5) can be overlaid on the reference model (e.g., FIG. 6) and then the non-reference model can be adjusted with respect to the reference model, as shown in FIG. 8.

In FIG. 8, a subsurface reference point 800 (e.g., origin of the coordinate system of the non-reference model) is shown which is used to adjust the non-reference model 802 (e.g., resistivity-based curtain section) with respect to the reference model 804. The non-reference model 802 can be tilted about the subsurface reference point 800 and with respect to the reference model 804. Based on the uncertainty of a trajectory based on the reference model 804, the amount of adjustment of the non-reference model 802 can be constrained. For example, as shown in FIG. 8, an upper limit 806 and a lower limit 808 are shown that are based on the uncertainty of a trajectory within the reference model 804 once the subsurface reference point 800 is reached. In addition to tilting, vertical and/or horizontal adjustment between the two models 802, 804 can be carried out, as indicated by adjustment axis 810. The tilt 812 of the non-reference model 802 is indicated about the subsurface reference point 800, with the tilt 812 being constrained within the upper limit 806 and the lower limit 808.

Those of skill in the art will appreciate that different models can be used as the reference and/or non-reference models. For example, although described above with the seismic model being the non-reference model and the resistivity model being the reference model, such configuration is not to be limiting. For example, in some embodiments, the seismic model can be the reference model and the reservoir navigation model (e.g., resistivity model) can be used as the non-reference model. As such, because the uncertainty of the position of the reservoir navigation model originates from the uncertainty of the well trajectory, the reservoir navigation model may be tilted to alter its position in the subsurface model. Tilting may be conducted around a subsurface reference point, which is the origin of the coordinate system of the non-reference model.

The coordinate system(s), as used in various embodiments of the present disclosure, can be of Cartesian or non-Cartesian nature. The latter may be related to features of the reservoir such as oil-water-contact. For example, the oil-water-contact may represent an x-y-plane. A secondary coordinate system (e.g., seismic or resistivity-based as above) may also be transformed in a more complex manner than just a tilt (as described above). For example, rotations about different axes and/or shifting vertically and/or horizontally are all contemplated herein. As noted, the alteration and/or adjustment of the position of a non-reference model in a reference subsurface model may be constrained by the maximum uncertainty of the position of the non-reference model.

Transforming a surface-based geospatial coordinate system (e.g., reference model coordinate system) into a reservoir-based geological-based coordinate system (non-reference model coordinate system) not only decreases uncertainty to where a bit is drilling within a formation, but it can also allow for a different, automated methods to geosteer.

That is, in one non-limiting example, a computing processor can be configured to understand relative spatial locations of geological features in relation to the bit and BHA. In some embodiments, the computing processor can be embedded in the BHA downhole (or, in other embodiments, may be located on the surface). The computing processor can be programmed to automatically follow a certain geological feature. For example, the computing processor can be configured to follow a bed boundary (e.g., bed boundaries 502 in FIG. 5). The computing process can employ sensors located on the BHA to determine or at least estimate how far a bed boundary is vertically and at which angle the borehole is drilled to the bed boundary. Based on this information, the computing processor can be programmed to follow the boundary for a certain and/or predefined distance. Other constraints may also be considered by the automated algorithm, as known in the art. Advantageously, when employing a downhole computing processor as provided herein, commands from the surface may be minimized, e.g., for adjustment of the distance of the BHA to the reference plane that is being followed. Steering automation as provided herein can also apply to an azimuth plane and not just a vertical plane. Enveloping decision processes for steering the entire well—such as optimum azimuthal direction—can be automated with surface processes as well.

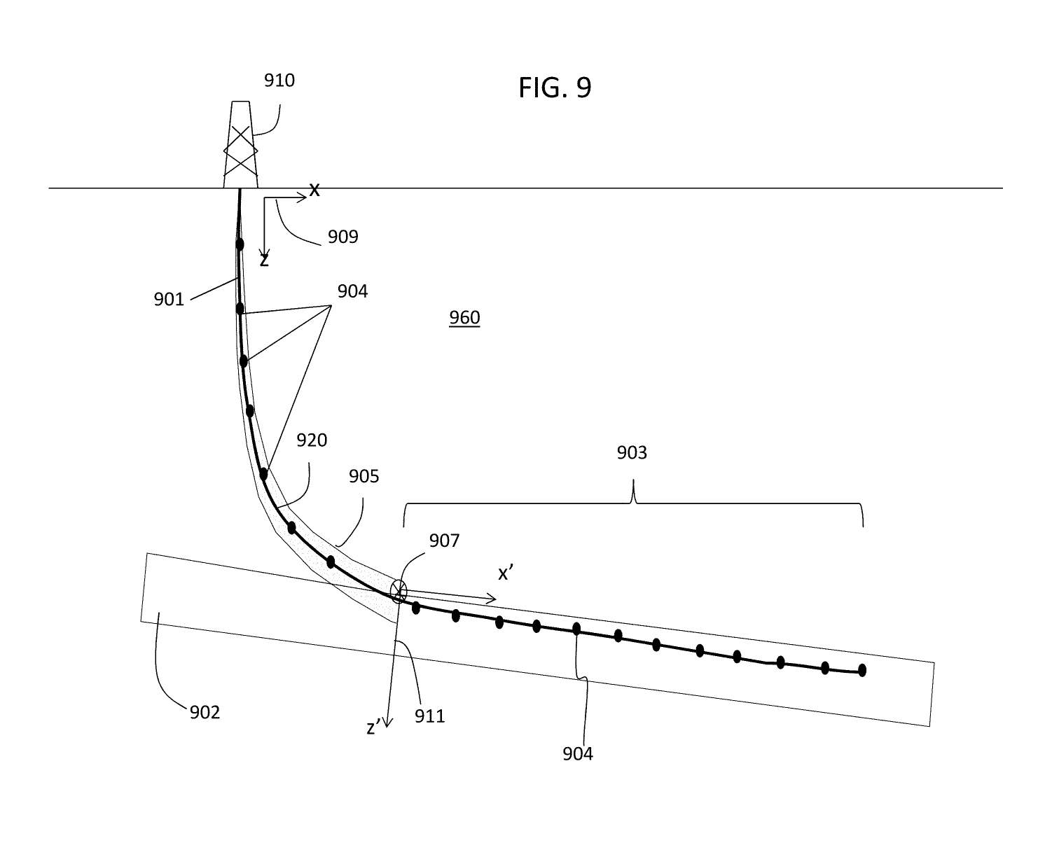

Turning now to FIG. 9, an example showing a first coordinate system (e.g., reference coordinate system) and a second coordinate system (e.g., non-reference coordinate system) in accordance with an embodiment of the present disclosure is shown. A well plan 901 is configured with a subsurface reference point 907, which is preset as the boundary between an earth formation 960 and a reservoir 902. The subsurface reference point 907 can be selected and predefined based on one or more models and/or formation evaluation logs from offset wells obtained prior to a drilling operation being carried out. In the embodiment of FIG. 9, the reservoir 902 is a tilted reservoir (e.g., having an inclination from a plane defined at the surface).

As shown, as the well path 901 extends downward from surface components 910 (e.g., a rig) to the subsurface reference point 907, a certain amount of uncertainty will be present in the position or location of the wellbore due to the uncertainty imposed from survey points 904 that are above the subsurface reference point 907 (e.g., as described above with respect to FIGS. 3A-3B). A well uncertainty region 905 is indicated in FIG. 9 and represents the uncertainty in position of a BHA and/or drill bit at various positions along the well plan 901. The initial drilling operation and well plan 901 is based on a first coordinate system 909, represented as x and z, with x being parallel to a surface and z being a vertical direction. The original of the first coordinate system 909 can be the location of the surface components 910 (e.g., where the borehole originates at the surface).

However, once the reservoir 902 (and thus subsurface reference point 907) is reached, within the uncertainty of well uncertainty region 905, the drilling operation is reset or changed to a second (e.g., adjusted) coordinate system 911 that is based on the subsurface reference point 907. The second coordinate system 911 has a first axis x′ and a second axis z′. In this embodiment, the first axis x′ is selected to run along a length of the reservoir 902 and the second axis z′ is selected to run perpendicular to the first axis x′ and into the reservoir 902 (e.g., a width or depth direction of the reservoir 902). The second coordinate system 911 can be set by a process as described above (e.g., FIG. 7).

Similar to that described above, the drilling operation within the reservoir 902 continues to include survey points 904. However, the survey points 904 within the reservoir 902 are calculated with respect to the second or adjusted coordinate system that is based on the subsurface reference point 907. This can lead to significant reductions in the amount of uncertainty that occurs within a reservoir navigation 903.

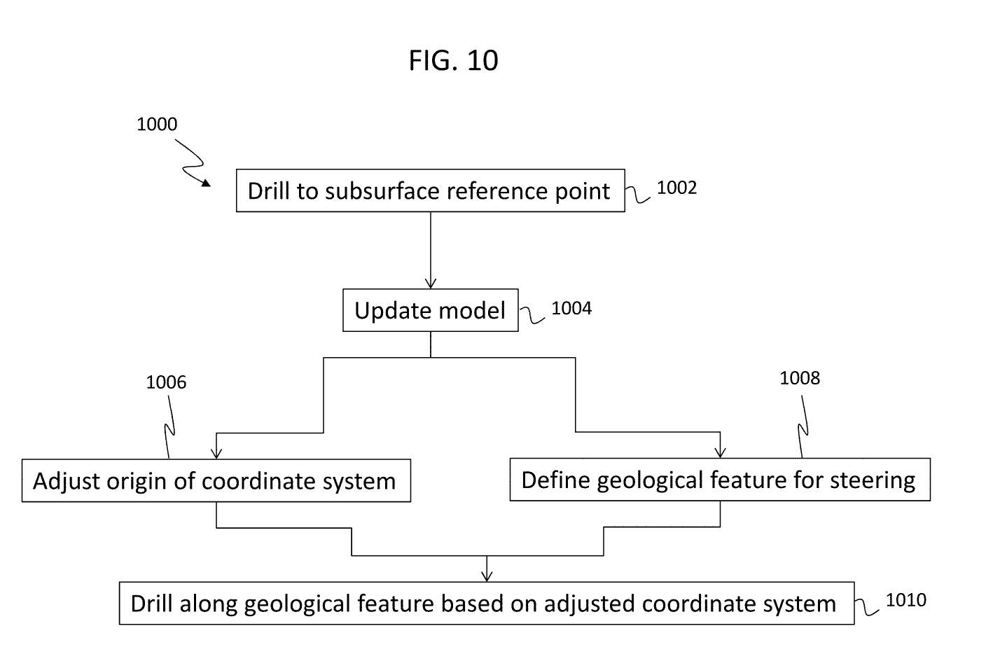

Turning now to FIG. 10, a flow process for drilling a wellbore in accordance with an embodiment of the present disclosure is shown. The flow process 1000 can be performed by a drilling system similar to that show and described above and/or variations thereon as known in the art. Various components can be employed in one or more computing systems (e.g., computers, controllers, etc.) that are positioned on the surface and/or downhole (e.g., in or on a BHA).

At block 1002, a wellbore is drilled to a subsurface reference point (e.g., anchor point, origin, etc.). The subsurface reference point can be a reservoir entry point, geological feature, or other desired or determined point. The initial drilling performed at block 1002 is based on a first coordinate system, with the origin set at the entry point and/or surface components of the drilling system. The coordinate system can be configured with a plane at the surface defining a plane of the coordinate system and a line extending normal therefrom into the formation is the third axis of the coordinate system.

Once the subsurface reference point is reached, the model for the drilling system can be updated. For example, if a seismic and/or resistivity model was used for the initial drilling operation, the model can be updated once the subsurface reference point is achieved, as shown at block 1004. Updating of the model may involve adjusting one or more models such that the models agree. For example, rotation, tilting, translation (along any axis or trajectory), etc. may be performed to modify and update the model.

Based on the modified model of block 1004, a new coordinate system origin can be defined, as shown at block 1006, and/or a geological feature can be defined for steering, as shown at block 1008. For example, the origin point of an adjusted or second coordinate system can be set at the point or location where the wellbore contacts or interfaces with a reservoir (e.g., as shown in FIG. 9). Moreover, the axes of the coordinate system can be modified and/or adjusted based on the new coordinate system. For example, as noted at block 1008, a geological feature can be defined, such as a formation structure, shapes, extent, etc. The defined geological feature can affect and/or be the basis for defining the axes of the second coordinate system. (e.g., as shown in FIG. 9).

With the adjusted origin and/or geological feature defined (blocks 1006, 1008) drilling may be performed along and/or with respect to the geological feature based on the adjusted coordinate system. Accordingly, inaccuracies and/or uncertainties in drilling operations can be minimized.

Advantageously, positional uncertainties of seismic and resistivity data relative to each other and/or to the wellbore can be reduced in real-time. Reduction of positional uncertainties can improve well or borehole placement and may thus increase production.

Moreover, advantageously, a geosteering process can be automated with the majority of the automation being downhole. Such automation (and downhole automation) can enable improved well and/or borehole placement relative to a reservoir and/or downhole formation. Furthermore, embodiments provided herein can enable increased rate or penetration (ROP). Traditionally, ROP can be held back to allow for operator (human) evaluation of speed based on multiple data sets pulsed up from downhole (e.g., time-delay and human operation). However, when automation is employed downhole as provided herein, part (or all) of the evaluation can done faster and with higher data density, and thus better data quality, automatically downhole.

Accordingly, advantageously, the operator can focus on fewer data sets and act faster if needed. The operator is also presented with fewer gaps in downhole data caused by downlinks and thus a more complete picture of what is going on can be provided to the operator. Ultimately, advantageously, embodiments provided herein can enable tighter and/or more accurate geological targets and reduce uncertainty toward geological boundaries, etc. Further, uncertainties caused by unknown or inaccurate depth correlations of geometrical versus geological features can be avoided.

Moreover, because embodiments provided herein are based on adjusted coordinate systems, such information and data sets can be uploaded into downhole tools (e.g., BHA) for auto-steering. Additionally, visualization with respect to the various coordinate systems can enable improved operator understanding depending on objectives (e.g., easier processing of geological information). Furthermore, the uncertainty of different geological position references to each other is smaller than the uncertainty of each to the geometric position. Hence, referencing the geological positions directly to each other, as provided herein, can reduce uncertainty.

### Embodiment 1

A method for drilling a borehole into the earth, the method comprising: drilling a first portion of a borehole with a drilling system comprising a disintegrating device, the first portion extending from the surface to a subsurface reference point, wherein steering within the first portion is performed based on a first coordinate system with a first origin; creating a second coordinate system, wherein the second coordinate system has a second origin that is related to subsurface reference point; and drilling a second portion of the borehole with the drilling system, wherein steering within the second portion is performed based on the second coordinate system.

### Embodiment 2

The method of any of the preceding embodiments, wherein steering within the first portion is conducted according to a first planned drill trajectory.

### Embodiment 3

The method of any of the preceding embodiments, wherein steering within the second portion is conducted according to a second planned drill trajectory.

### Embodiment 4

The method of any of the preceding embodiments, wherein the subsurface reference point is a geological feature.

### Embodiment 5

The method of any of the preceding embodiments, further comprising evaluating a relative position of a subsurface reference target and the borehole after the second coordinate system is created.

### Embodiment 6

The method of any of the preceding embodiments, wherein steering of the first or second portion is conducted based on a first subsurface model.

### Embodiment 7

The method of any of the preceding embodiments, wherein a first drill trajectory plan is based on a first subsurface model.

### Embodiment 8

The method of any of the preceding embodiments, wherein steering of the first portion is conducted based on the first subsurface model and steering of the second portion is conducted based on a second subsurface model.

### Embodiment 9

The method of any of the preceding embodiments, wherein a second drill trajectory plan is based on the second subsurface model.

### Embodiment 10

The method of any of the preceding embodiments, wherein the first subsurface model is based on data measured at or near the surface.

### Embodiment 11

The method of any of the preceding embodiments, wherein the data are seismic data.

### Embodiment 12

The method of any of the preceding embodiments, further comprising detecting the subsurface reference point with a tool located within the borehole.

### Embodiment 13

A system for controlling a trajectory of a borehole being drilled into the earth, the apparatus comprising: a drilling system comprising a disintegrating device and a steering system coupled to the disintegrating device configured to steer the disintegrating device, the disintegrating device and steering system configured to drill the borehole by receiving steering commands for controlling parameters of the drilling system; and a control unit configured to provide the steering commands to the steering system, the control unit configured to: control the disintegrating device to drill a first portion of a borehole, the first portion extending from the surface to a subsurface reference point, wherein steering within the first portion is performed based on a first coordinate system with a first origin; creating a second coordinate system, wherein the second coordinate system has a second origin that is related to the subsurface reference point; and controlling the disintegrating device and steering system to drill a second portion of the borehole, wherein steering within the second portion is performed based on the second coordinate system.

### Embodiment 14

The system of any of the preceding embodiments, wherein the reference point is a geological feature.

### Embodiment 15

The system of any of the preceding embodiments, wherein the control unit is further configured to evaluate a relative position of a subsurface target and the borehole after the second coordinate system is created.

### Embodiment 16

The system of any of the preceding embodiments, wherein steering of the first or second portion is conducted based on a first subsurface model.

### Embodiment 17

The system of any of the preceding embodiments, wherein steering of the first portion is conducted based on the first subsurface model and steering of the second portion is conducted based on a second subsurface model.

### Embodiment 18

The system of any of the preceding embodiments, wherein the first subsurface model is based on data measured at or near the surface.

### Embodiment 19

The system of any of the preceding embodiments, wherein the data are seismic data.

### Embodiment 20

The system of any of the preceding embodiments, the control unit further configured to detect the subsurface reference point with a tool located within the borehole.

In support of the teachings herein, various analysis components may be used, including a digital and/or an analog system. For example, the downhole electronics, the computer processing systems, the downhole sensors, the drilling/production parameter controllers, the steering systems, the actuators and/or other components discussed herein may include digital and/or analog systems. Further, the systems and configurations described herein may have components such as processors, storage media, memory, inputs, outputs, communications links (e.g., wired, wireless, pulsed mud, optical, etc.), user interfaces (e.g., display, printer, etc.), software programs, signal processors (e.g., digital, analog) and other such components (e.g., resistors, capacitors, inductors, etc.) to provide for operation and analyses of the apparatus and processes disclosed herein in any of several manners well-appreciated in the art. It is considered that these teachings may be, but need not be, implemented in conjunction with a set of computer executable instructions stored on a non-transitory computer readable medium, including memory (ROMs, RAMs), optical (CD-ROMs), or magnetic (disks, hard drives), or any other type that when executed causes a computer to implement the method of the present disclosure. These instructions may provide for equipment operation, control, data collection and analysis and other functions deemed relevant by a system designer, owner, user or other such personnel, in addition to the functions described in this disclosure.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms. The term “configured” relates to one or more structural limitations of a device that are required for the device to perform the function or operation for which the device is configured.

The flow diagrams and schematic diagrams depicted herein are just examples. There may be many variations to these diagrams or the steps (or operations) described therein without departing from the present disclosure. For instance, the steps may be performed in a differing order, or steps may be added, deleted, or modified. All of these variations are considered a part of the claims appended herewith.

While one or more embodiments have been shown and described, modifications and substitutions may be made thereto without departing from the present disclosure. Accordingly, it is to be understood that the present disclosure has been described by way of illustrations and not limitation.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the embodiments disclosed and/or variations thereof.

While the present disclosure has been described with reference to non-limiting, example embodiments, it will be understood that various changes may be made and equivalents may be substituted for elements thereof without departing from the scope of the present disclosure. In addition, many modifications will be appreciated to adapt a particular instrument, situation or material to the teachings of the present disclosure without departing from the essential scope thereof. Therefore, it is intended that the claims not be limited to the particular embodiment(s) disclosed as the best mode contemplated for carrying out the concepts herein, but will include all embodiments falling within the scope of the appended claims.

What is claimed is:

1. A method for drilling a borehole into the earth, the method comprising:
drilling a first portion of a borehole with a drilling system comprising a disintegrating device, the first portion extending from the surface to a subsurface reference point, wherein steering within the first portion is performed based on a first coordinate system with a first origin;
creating a second coordinate system, wherein the second coordinate system has a second origin that is related to subsurface reference point; and
drilling a second portion of the borehole with the drilling system, wherein steering within the second portion is performed based on the second coordinate system.

2. The method according to claim 1, wherein steering within the first portion is conducted according to a first planned drill trajectory.

3. The method according to claim 1, wherein steering within the second portion is conducted according to a second planned drill trajectory.

4. The method according to claim 1, wherein the subsurface reference point is a geological feature.

5. The method according to claim 1, further comprising evaluating a relative position of a subsurface reference target and the borehole after the second coordinate system is created.

6. The method according to claim 1, wherein steering of the first or second portion is conducted based on a first subsurface model.

7. The method according to claim 6, wherein a first drill trajectory plan is based on a first subsurface model.

8. The method according to claim 6, wherein steering of the first portion is conducted based on the first subsurface model and steering of the second portion is conducted based on a second subsurface model.

9. The method according to claim 8, wherein a second drill trajectory plan is based on the second subsurface model.

10. The method according to claim 6, wherein the first subsurface model is based on data measured at or near the surface.

11. The method according to claim 10, wherein the data are seismic data.

12. The method according to claim 1, further comprising detecting the subsurface reference point with a tool located within the borehole.

13. A system for controlling a trajectory of a borehole being drilled into the earth, the apparatus comprising:
a drilling system comprising a disintegrating device and a steering system coupled to the disintegrating device configured to steer the disintegrating device, the disintegrating device and steering system configured to drill the borehole by receiving steering commands for controlling parameters of the drilling system; and
a control unit configured to provide the steering commands to the steering system, the control unit configured to:
control the disintegrating device to drill a first portion of a borehole, the first portion extending from the surface to a subsurface reference point, wherein steering within the first portion is performed based on a first coordinate system with a first origin;
creating a second coordinate system, wherein the second coordinate system has a second origin that is related to the subsurface reference point; and
controlling the disintegrating device and steering system to drill a second portion of the borehole, wherein steering within the second portion is performed based on the second coordinate system.

14. The system according to claim 13, wherein the reference point is a geological feature.

15. The system according to claim 13, wherein the control unit is further configured to evaluate a relative position of a subsurface target and the borehole after the second coordinate system is created.

16. The system according to claim 13, wherein steering of the first or second portion is conducted based on a first subsurface model.

17. The system according to claim 16, wherein steering of the first portion is conducted based on the first subsurface model and steering of the second portion is conducted based on a second subsurface model.

18. The system according to claim 16, wherein the first subsurface model is based on data measured at or near the surface.

19. The system according to claim 18, wherein the data are seismic data.

20. The system according to claim 13, the control unit further configured to detect the subsurface reference point with a tool located within the borehole.
